(19) United States
(12) Patent Application Publication
(10) Pub. No.: US 2016/0084475 A1
(43) Pub. Date: Mar. 24, 2016

(54) LIGHTING APPARATUS

(71) Applicant: IWASAKI ELECTRIC CO., LTD., Tokyo (JP)

(72) Inventors: Kazutoshi FUJII, Konosu City (JP); Tadashi OOMURO, Gyoda City (JP); Takahito SHIMIZU, Gyoda City (JP)

(73) Assignee: IWASAKI ELECTRIC CO., LTD., Tokyo (JP)

(21) Appl. No.: 14/890,274

(22) PCT Filed: Aug. 22, 2013
(86) PCT No.: PCT/JP2013/072432

§ 371 Date: Nov. 10, 2015

(30) Foreign Application Priority Data
May 31, 2013 (JP) 2013-115351

(51) Int. Cl. F21V 7/00; F21V 29/76; F21V 23/02; F21V 7/04

(52) U.S. Cl. CPC F21V 7/0083; F21V 7/04; F21V 29/76; F21V 23/02; F21Y 2105/001

(57) ABSTRACT

A lighting apparatus that can easily change light distribution is provided. In an LED lighting apparatus in which an LED as a light source, and a reflector having a reflecting surface in a shape of a curved surface of revolution are accommodated in an apparatus main body, the reflector is made separable into a base end side and a tip end side of the reflecting surface, and a tip end of the base end side part is protruded from the apparatus main body .

### CROSS-REFERENCE TO RELATED PATENT APPLICATIONS

This application is a U.S. National Phase Application under 35 U.S.C. §371 of International Patent Application No. PCT/JP2013/072432, filed Aug. 22, 2013, and claims the benefit of Japanese Patent Application No. 2013-115351, filed on May 31, 2013, all of which are incorporated by reference in their entirety herein. The International Application was published in Japanese on Dec. 4, 2014 as International Publication No. WO/2014/192169 under PCT Article 21(2).

### FIELD OF THE INVENTION

The present invention relates to a lighting apparatus.

### BACKGROUND OF THE INVENTION

A lighting apparatus having a plurality of LEDs as a light source is widely known. Further, there is known a lighting apparatus that performs light distribution control by providing a concave reflecting mirror at each of a plurality of LEDs (for example, Japanese Patent Laid-Open No. 2012-9280).

### Technical Problem

However, in the conventional lighting apparatus, main light distribution is defined by the concave reflecting mirrors. Consequently, it is difficult to change light distribution properly in accordance with an installation location, a purpose of lighting and the like.

The present invention is made in the light of the aforementioned circumstances, and has an object to provide a lighting apparatus that can easily change light distribution.

### SUMMARY OF THE INVENTION

### Solution to Problem

In order to achieve the above described object, the present invention is directed to a lighting apparatus in which a light source and a reflector having a reflecting surface that is in a shape of a curved surface of revolution are accommodated in an apparatus main body, wherein the reflector is made separable into a base end side and a tip end side of the reflecting surface, and at least a tip end of a part at the base end side is protruded from the apparatus main body.

Further, the present invention is the above described lighting apparatus, and further includes a coupling section that couples the part at the base end side and a part at the tip end side of the reflector.

Further, the present invention is the above described lighting apparatus, wherein the reflector has a plurality of reflecting surfaces that are connected by a connecting section, and the coupling section to which the part at the base end side and the part at the tip end side are inserted and coupled is included in the connecting section.

Further, the present invention is the above described lighting apparatus, wherein a plurality of the reflectors are included, and the respective reflectors are arranged inside the apparatus main body.

Further, the present invention is the above described lighting apparatus, wherein the light source includes a light-emitting element, and a light-emitting element substrate on which the light-emitting element is mounted, and a spacer is provided between the part at the base end side of the reflector and the light-emitting element substrate.

Further, the present invention is the above described lighting apparatus, wherein the spacer has a surface that continues to a reflecting surface of the part at the base end side of the reflector, and a shape of the surface is matched with a shape in a state of the reflecting surface being extended to a side of the light-emitting element substrate.

Further, the present invention is the above described lighting apparatus, wherein the reflector integrally includes a plurality of the reflecting surfaces that are disposed so that rotation axes are parallel with one another.

Further, the present invention is the above described lighting apparatus, and further includes a power supply box in which an electric circuit that supplies power to the light source is accommodated, wherein a plurality of heat radiation fins that extend in one direction is provided on a rear surface of the apparatus main body, and bosses that support the power supply box with a gap provided between the heat radiation fins and the power supply box are provided to stand in a space that is made by the heat radiation fins being partially removed.

Further, the present invention is the above described lighting apparatus, wherein at least one of the heat radiation fins is connected to the boss.

### ADVANTAGEOUS EFFECTS OF INVENTION

According to the present invention, the reflector is made separable into the base end side and the tip end side of the reflecting surface, and therefore, by using the reflector by removing the tip end side, or by replacing the tip end side with the one having a different reflectance property and/or a light distribution property, the distribution pattern of the reflecting surface of the reflector can be changed arbitrarily and easily.

Further, at least the tip end of the part at the base end side is protruded from the apparatus main body, and therefore, even when the reflector is used by removing the tip end side from the reflector, the emission light from the reflector is not shielded by the apparatus main body, and the apparatus efficiency is not reduced. Further, the depth of the apparatus main body in which the reflector is accommodated can be made small, and therefore, reduction in weight of the apparatus main body is achieved.

### BRIEF DESCRIPTION OF THE DRAWINGS

These and other features and advantages of the present invention will become more readily appreciated when considered in connection with the following detailed description and appended drawings, wherein like designations denote like elements in the various views, and wherein:

FIG. 1 is a view showing an external configuration of an LED lighting apparatus according to an embodiment of the present invention, FIG. 1 (A) is a front view and FIG. 1 (B) is a side view.

FIG. 2 is a sectional view taken along a line A-A in FIG. 1 (A).

FIG. 3 is a view showing a configuration of an apparatus main body, FIG. 3 (A) is a front view, FIG. 3 (B) is a rear view, FIG. 3 (C) is a side view, and FIG. 3 (D) is a bottom view.

FIG. 4 is a sectional view taken along a line B-B in FIG. 3 (A).

FIG. 5 is a configuration view of a front cover, FIG. 5 (A) is a front view, FIG. 5 (B) is a side view, FIG. 5 (C) is a bottom view, and FIG. 5 (D) is a sectional view taken along a line C-C in FIG. 5 (A).

FIG. 6 is a configuration view of a power supply box main body, FIG. 6 (A) is a front view, FIG. 6 (B) is a top view, FIG. 6 (C) is a bottom view, FIG. 6 (D) is a left side view and FIG. 6 (E) is a rear view.

FIG. 7 is a sectional view taken along a line D-D in FIG. 6 (A).

FIG. 8 is a sectional view of a reflector.

FIG. 9 is a configuration view of a base end side part, FIG. 9 (A) is a front view, FIG. 9 (B) is a top view, FIG. 9 (C) is a bottom view, and FIG. 9 (D) is a left side view.

FIG. 10 is a configuration view of a tip end side part, FIG. 10 (A) is a front view, FIG. 10 (B) is a top view, FIG. 10 (C) is a bottom view, and FIG. 10 (D) is a left side view.

FIG. 11 is an explanatory view of a spacer.

### DETAILED DESCRIPTION OF THE INVENTION

Hereinafter, an embodiment of the present invention will be described with reference to the drawings.

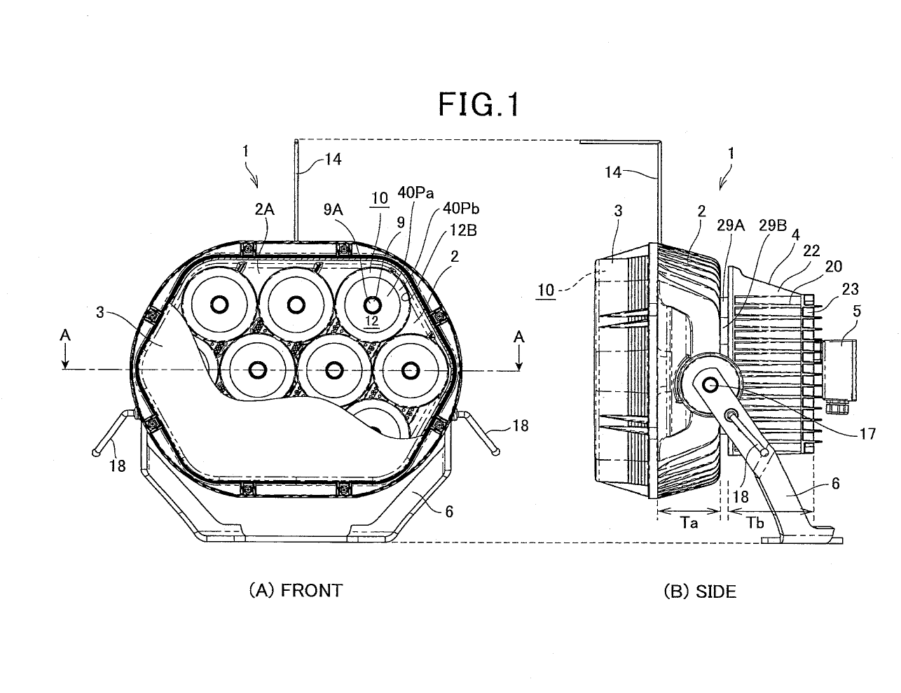

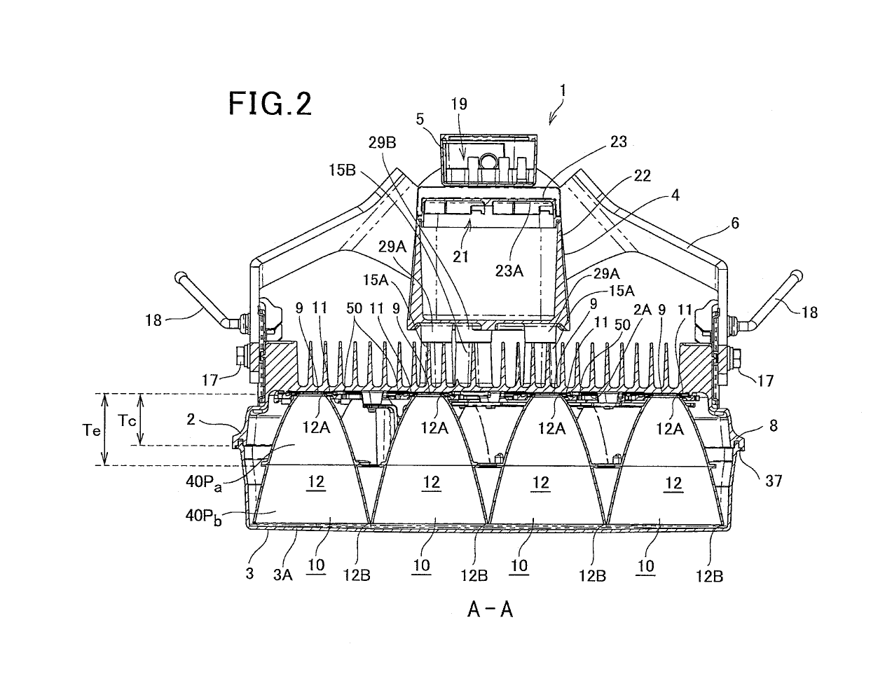

FIG. 1 is a view showing an external configuration of an LED lighting apparatus 1 according to the present embodiment, FIG. 1 (A) is a front view, and FIG. 1 (B) is a side view. Further, FIG. 2 is a sectional view taken along a line A-A in FIG. 1 (A).

The LED lighting apparatus 1 is a floodlight that is mainly used in outdoor illumination lighting, stage lighting, sports lighting, stadium lighting or the like, and is configured to be suitable for lighting to a distant spot that is at a distance of several tens meters to a hundred and several tens meters. Specifically, as shown in FIG. 1 and FIG. 2, the LED lighting apparatus 1 includes an apparatus main body 2, a front cover 3, a power supply box 4, a connection box 5 and an arm 6.

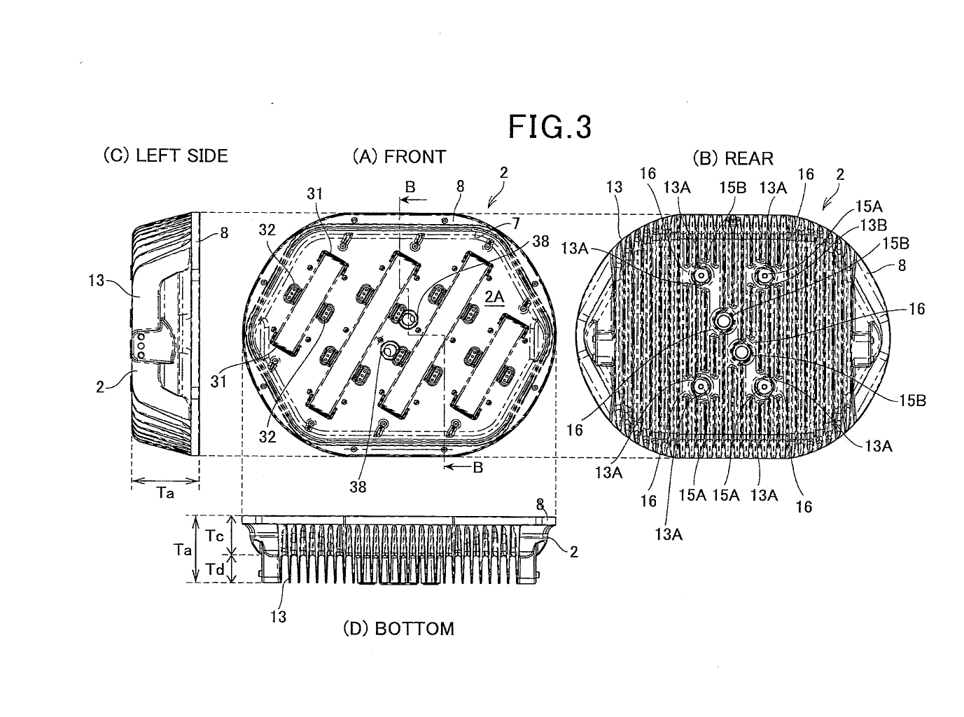

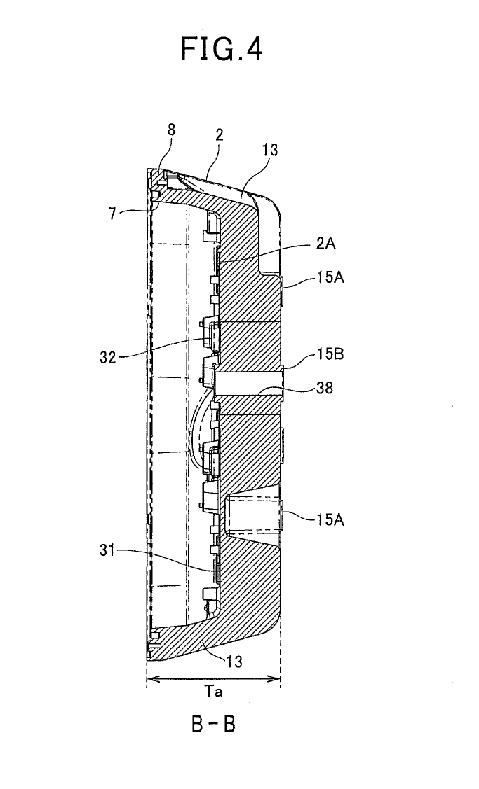

FIG. 3 is a view showing a configuration of the apparatus main body 2, FIG. 3 (A) is a front view, FIG. 3 (B) is a rear view, FIG. 3 (C) is a left side view, and FIG. 3 (D) is a bottom view. Further, FIG. 4 is a sectional view taken along a line B-B in FIG. 3 (A).

As shown in FIG. 3 and FIG. 4, the apparatus main body 2 forms a tray shape with a front opened, and is formed by die casting with use of an aluminum alloy or the like that is a high thermoconductive material as a material. As shown in FIG. 2, in the apparatus main body 2, a plurality of LEDs 9 as a light source, and a plurality of reflectors 10 that control light distribution of the LEDs 9 are accommodated.

In the LED 9, a light-emitting device (a so-called COB type LED) of a chip-on board (COB) structure in which a planar light-emitting section 9A in a substantially circular shape (a square is also possible) in a plan view is formed by densely disposing a large number of LED elements is used in order to obtain a large quantity of light and high brightness. The LED 9 is mounted on a ceramics substrate 11 that is excellent in an electrical insulation property and thermal conductivity, and is placed on a bottom surface 2A of the above described apparatus main body 2. Thereby, heat generated in the LED 9 can be smoothly transmitted and dissipated to the apparatus main body 2 through the ceramics substrate 11 while the electrical insulation of the LED 9 and the apparatus main body 2 is kept by the ceramics substrate 11. The LED 9 is not necessarily limited to the COB type LED. Further, the mounting substrate for the LED 9 is not limited to the ceramics substrate 11.

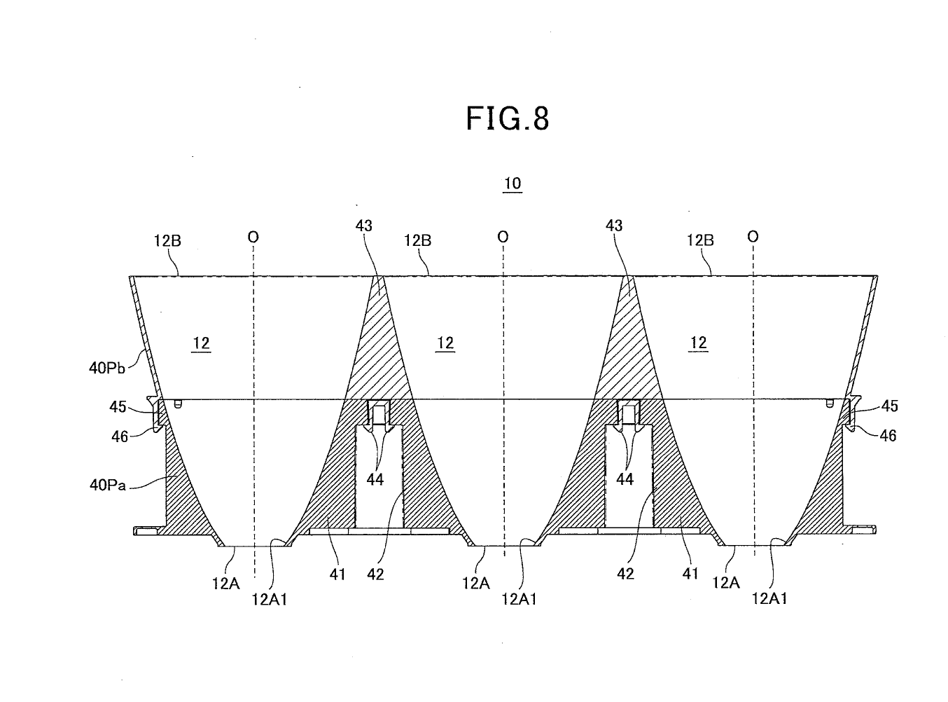

The reflector 10 has a reflecting surface 12 corresponding to the LED 9, as shown in FIG. 2. The reflecting surface 12 is formed on a paraboloid of revolution that is one mode of a shape of a surface of revolution, a bottom opening 12A1 is formed in a base end section 12A of the reflecting surface 12, and the above described LED 9 is disposed in a position facing the bottom opening 12A1. An optical axis of the LED 9 and a rotation axis (a central axis O (FIG. 8)) of the reflecting surface 12 are disposed coaxially, and in the reflecting surface 12, the light of the LED 9 is collimated and is emitted from a tip end section 12B. The reflector 10 is formed from a resin material, and is reduced in weight as compared with a case where the reflector 10 is formed with a metal material as a base material. Mirror finish such as metal coating is applied to the reflecting surface 12, and whereby a high reflectivity is obtained.

In the LED lighting apparatus 1, a plurality of sets of LEDs 9 and reflecting surfaces 12 are included, and the respective reflecting surfaces 12 are disposed with the central axes O made parallel with one another. More specifically, the respective reflecting surfaces 12 are disposed most densely in front view, as shown in FIG. 1. Thereby, respective emission light of the reflecting surfaces 12 are not separated, and collimated light with a large luminous flux section (a so-called spot diameter) are obtained as irradiation light. Further, since a high brightness type LED is used for the LED 9 as the light source, a distant object at a distance of several tens meters to a hundred and several tens meters can be illuminated with a high luminous intensity. Further, in the LED lighting apparatus 1, a sighting device 14 is provided at an upper portion of the apparatus main body 2 as shown in FIG. 1, and the irradiation direction of the irradiation light can be easily matched to a distant object.

As shown in FIG. 3 (A), engaging pieces 31 that position the ceramics substrate 11 of the LED 9 are provided on the bottom surface 2A of the apparatus main body 2, and screw cramp sections 32 that fix the reflector 10 by screwing are provided in correspondence to the engaging pieces 31. By these engaging pieces 31 and screw cramp sections 32, the ceramics substrate 11 and the reflector 10 are relatively positioned, and the LED 9 is accurately disposed on the base end section 12A of the reflecting surface 12.

Note that the reflecting surface 12 may be configured to be made an ellipsoid of revolution instead of a paraboloid of revolution to emit light which is concentrated on a distant place, or may be formed into another surface of revolution such as a hyperboloid of revolution. Further, the reflecting surfaces 12 in different shapes of surfaces of revolution may be used in combination. For example, a plurality of reflecting surfaces 12 may be configured so that some of the plurality of reflecting surfaces 12 are formed into paraboloids of revolution, the others may be formed into ellipsoids of revolution, and whereby collimated light and condensed light may be emitted exclusively or simultaneously.

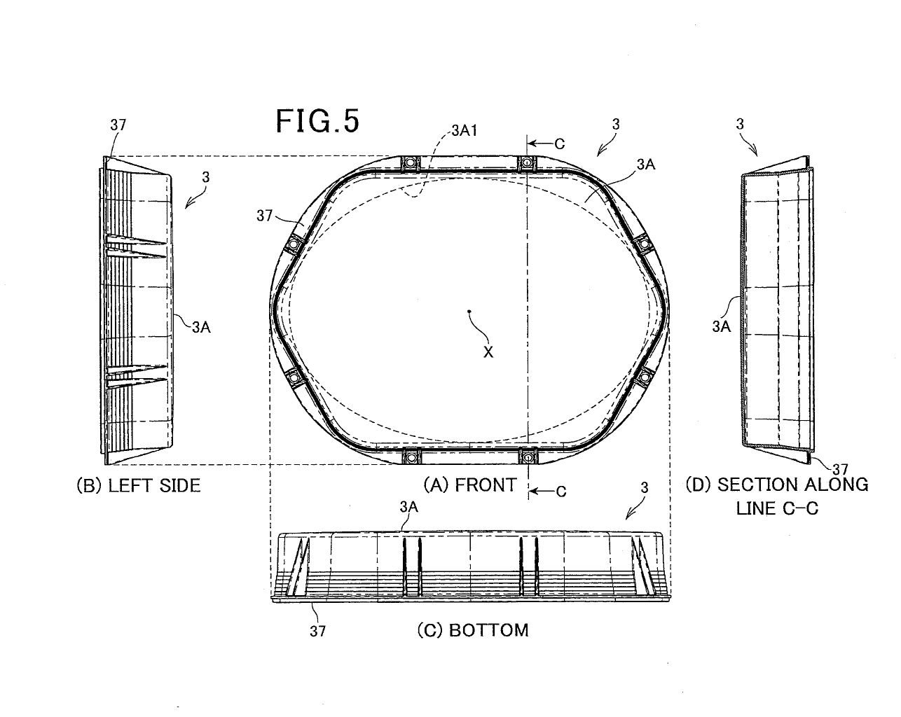

FIG. 5 is a configuration view of the front cover 3, FIG. 5 (A) is a front view, FIG. 5 (B) is a left side view, FIG. 5 (C) is a bottom view, and FIG. 5 (D) is a sectional view taken along a line C-C in FIG. 5 (A).

The front cover 3 is a cover member of a transparent resin that covers a front surface of the apparatus main body 2, and as shown in FIG. 5, the front cover 3 forms a tray shape that has a plane section 3A in substantially the same size and shape as a front opening 7 of the apparatus main body 2, and a flange 37 is formed at an edge portion. As shown in FIG. 3, a flange 8 is also integrally formed at an edge portion of the front opening 7 of the apparatus main body 2, and the flange 37 of the front cover 3 is fixed to the flange 8 by screwing.

Since the plurality of reflecting surfaces 12 are provided side by side in the front opening 7, in the LED lighting apparatus 1, an opening area of the front opening 7 and an area of the plane section 3A of the front cover 3 also become large proportionally to the number of the reflecting surfaces 12. However, as the plane section 3A becomes wider, a strain is generated in the plane more easily, and such a strain that a central portion in the plane is recessed to a side of the apparatus main body 2 is sometimes generated. When a recess relating to the plane section 3A is present, a spider's web that covers the recessed portion is readily made, and there arises a problem of frequently requiring cleaning maintenance.

Therefore, as shown in FIG. 5 (A), in the LED lighting apparatus 1, a protruded section 3A1 is formed on the plane section 3A of the front cover 3 by slightly protruding a region including at least a central portion X. By the protruded section 3A1, the recess of the plane section 3A is restrained, and therefore, a spider's web is difficult to make.

The power supply box 4 is a container that accommodates a power supply circuit 21 (FIG. 2) of the LED 9, is formed from an aluminum alloy or the like that is a high thermoconductive material, includes a power supply box main body 22 and a lid body 23 that closes an opening at a front surface, and the connection box 5 is fixed to the lid body 23, as shown in FIG. 1 (B). The connection box 5 is a box body in which a terminal board 19 that connects wiring of an external power supply such as a commercial power supply is accommodated. A through-hole (not illustrated) is provided in the connection box 5 and the lid body 23, wiring of the power supply circuit 21 is led into the connection box 5 through the through-hole and is connected to the terminal board 19, and whereby the power supply circuit 21 is connected to the external power supply. The power supply circuit 21 is a power conversion circuit that converts power of the external power supply into a direct-current power that is necessary to drive the LED 9. In the power supply box 4, various electric circuits are also accommodated in accordance with necessity, besides the power supply circuit 21.

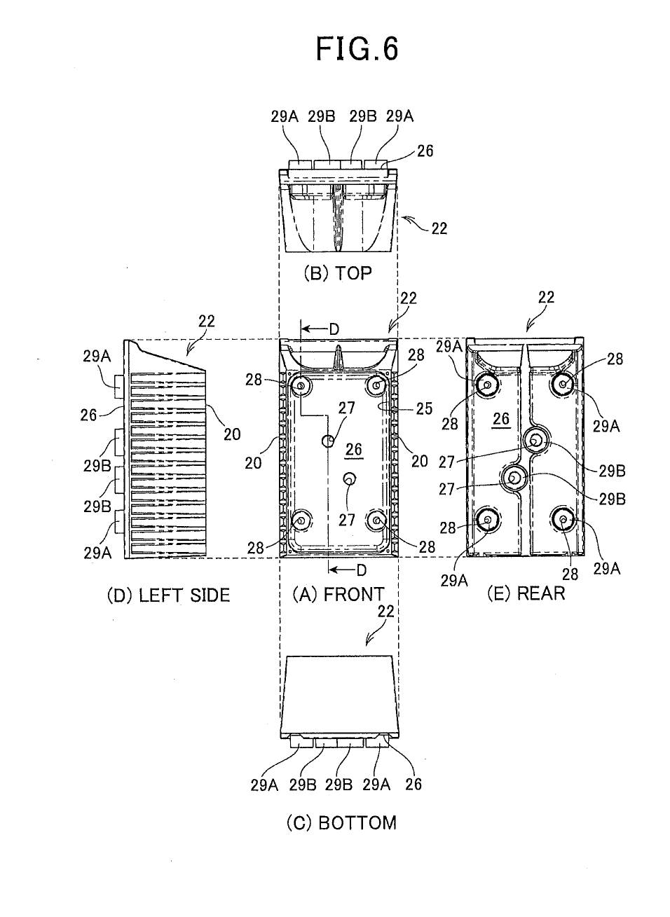

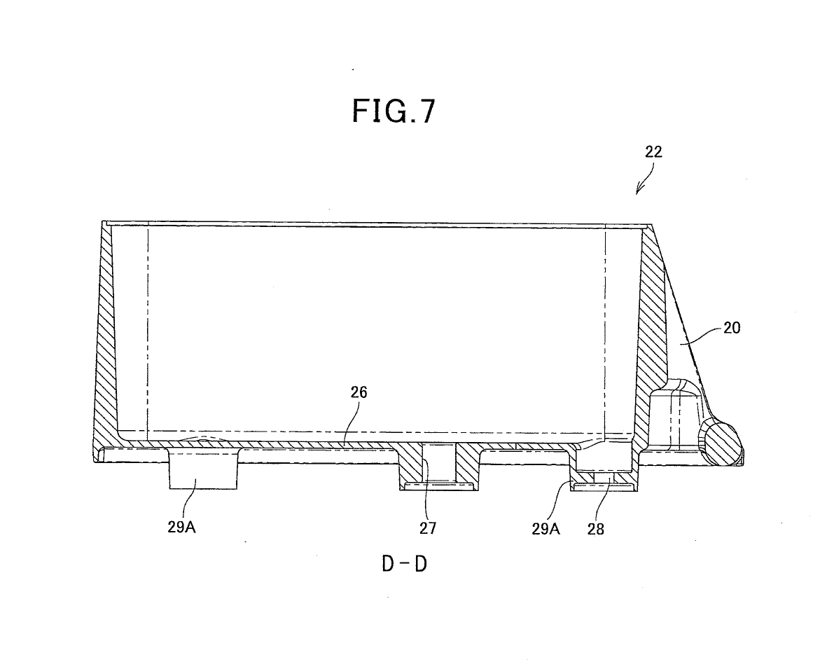

FIG. 6 is a configuration view of the power supply box main body 22, FIG. 6 (A) is a front view, FIG. 6 (B) is a top view, FIG. 6 (C) is a bottom view, FIG. 6 (D) is a left side view and FIG. 6 (E) is a rear view. Further, FIG. 7 is a sectional view taken along a line D-D in FIG. 6 (A).

The power supply box main body 22 is a case body in a shape of a rectangular parallelepiped with a front surface opened, and a large number of heat radiation fins 20 are formed on a left and a right side surfaces to enhance internal heat dissipation. The lid body 23 is a substantially-rectangular-plate-shaped body that covers a front opening 25 of the power supply box main body 22 and that is fixed by screwing, and as described above, the connection box 5 is fixed to a face side thereof.

A plurality of wiring holes 27 are opened in a bottom surface 26 of the power supply box main body 22, and the wiring of the power supply circuit 21 is led out to the side of the apparatus main body 2 through these wiring holes 27. Further, in four corners of the bottom surface 26, screw holes 28 for fastening the power supply box main body 22 to a rear surface of the apparatus main body 2 by screwing are provided, and bosses 29A are provided to stand on a face side of the bottom surface 26 in correspondence to these screw holes 28. These bosses 29A form columnar shapes which has predetermined heights and in which screw holes are provided along central axes, and whereby the power supply box main body 22 is fixed by screwing with a gap provided between the rear surface of the apparatus main body 2 and the power supply box main body 22. Further, tubular bosses 29B with predetermined heights are provided at the respective wiring holes 27, and the wiring of the power supply circuit 21 is introduced into the apparatus main body 2 through the bosses 29B.

The power supply box main body 22 is attached with the gap provided between the apparatus main body 2 and the power supply box main body 22, whereby flow of heat between the power supply box main body 22 and the apparatus main body 2 is shut off. In addition to this, as shown in FIG. 2, in the power supply box 4, the power supply circuit 21 is attached to a back surface 23A of the lid body 23, and an influence which heat generated in the power supply circuit 21 has on the apparatus main body 2 is restrained more reliably.

Further, a configuration is adopted in which a difference is provided in height between bosses 15A and 15B, for the wiring holes 27, that are provided to stand on the rear surface of the apparatus main body 2 and the power supply box main body 22, and the bosses 29A and 29B that have the screw holes 28, heights of the bosses 29A and 29B for the screw holes 28 are formed to be slightly lower than heights of the bosses 15A and 15B, and a gap is provided on contact surfaces of the bosses having the screw holes 28 at a time of contact of the bosses for the wiring holes 27, and bolts are fitted in and fixed to the screw holes 28, whereby contact of the bosses 15A and 115B for the wiring holes 27 can be made more reliably.

Furthermore, a configuration is provided in which ring-shaped packings (O-rings in the present embodiment (not illustrated)) are interposed between the bosses 15A and 15B, and the bosses 29A and 29B, and therefore, when bolts are fitted in and fixed to the screw holes 28 of the bosses 29A and 29B, a water proofing property of the wiring holes 27 between the apparatus main body 2 and the power supply box main body 22 is enhanced.

The arms 6 are fixing metal fittings for attaching and fixing the apparatus main body 2 to the installation surface, and are rotatably attached to both a left and a right sides of the apparatus main body 2 to sandwich the apparatus main body 2, as shown in FIG. 1 and FIG. 2. A nut 17 is provided at a rotating shaft of the arm 6, and rotation of the apparatus main body 2 is restricted by fastening of the nut 17. Further, in the arm 6, a lever 18 that is provided for a rotational operation of the apparatus main body 2 is provided.

In the LED lighting apparatus 1, the reflector 10 is protruded to the front surface side of the apparatus main body 2, and therefore if no measure is taken, the center of gravity deviates to the front surface side. Therefore, as shown in FIG. 1 (B), a thickness Tb of the power supply box 4 is formed to be substantially the same as or larger than a thickness Ta of the apparatus main body 2 (Tb>Ta in the present embodiment), whereby a deviation of the center of gravity to the front surface side of the LED lighting apparatus 1 is restrained. In addition to this, the power supply box 4 is disposed to be separated from the apparatus main body 2, the power supply circuit 21 and the connection box 5 are provided at the side of the lid body 23 of the power supply box 4 as described above, and therefore, the deviation of the center of gravity is restrained more effectively.

That is, in the LED lighting apparatus 1, a weight balance in the longitudinal direction (a direction connecting the front surface and the rear surface) at a time of rotatably supporting the apparatus main body 2 with the arms 6 becomes favorable, and stability of installation is enhanced.

As described above, in the LED lighting apparatus 1, the COB type LED which is one example of a high-power type light-emitting element is used for the LED 9. Consequently, the ceramics substrate 11 on which the LED 9 is mounted is directly attached to the apparatus main body 2 which is formed from a high thermoconductive material, and the heat generated in the LED 9 is transmitted to the apparatus main body 2, whereby a temperature of the LED 9 does not exceed a predetermined operation temperature.

Further, as shown in FIG. 3, a large number of heat radiation fins 13 are integrally formed on the rear surface of the apparatus main body 2, and heat dissipation of the apparatus main body 2 is enhanced. The respective heat radiation fins 13 are formed into shapes of thin plates that extend from the upper surface to the bottom surface of the apparatus main body 2, and are arranged at fixed intervals in a lateral width direction. The aforementioned thickness Ta of the apparatus main body 2 is a value including a depth Tc of the container of the apparatus main body 2 and a height Td of the heat radiation fin 13, as shown in FIG. 3 (D).

Further, on the rear surface of the apparatus main body 2, the bosses 15A and 15B are integrally provided to stand. The boss 15A is a member that is screwed with the boss 29A of the power supply box 4, and the boss 15B is a tubular member through which a through-hole 38 that allows wiring to pass by being connected to the boss 29B penetrates. The bosses 15A and 15B are placed in a stand placement space 16 that is formed by partially cutting out a plurality of heat radiation fins 13, as shown in FIG. 3 (B). As shown in FIG. 3 (B), connection sections 13A to which any of the heat radiation fins 13 are connected are provided at peripheral surfaces of the respective bosses 15A and 15B, and whereby heat accumulation in the bosses 15A and 15B is prevented. These heat radiation fins 13, and the bosses 15A and 15B are integrally molded by die-casting of the apparatus main body 2.

Incidentally, the LED lighting apparatus 1 includes the reflector 10 for controlling light distribution as described above, and is configured to be able to change light distribution by the reflector 10 easily.

That is, as shown in FIG. 2, the reflector 10 is configured to be separable into a base end side part 40Pa and a tip end side part 40Pb between the base end section 12A which is the bottom portion side of the reflecting surface 12 and the tip end section 12B. By the configuration, the reflector 10 is used by removing the tip end side part 40Pb from the base end side part 40Pa, or the tip end part 40Pb having a different reflectance property and/or light distribution property is used in place of the original tip end part 40Pb, whereby an distribution pattern of the reflecting surface 12 which is formed of the combination of the base end side part 40Pa and the tip end side part 40Pb can be easily changed arbitrarily. Further, light distribution is also made changeable by a combination of the reflecting surface 12 and an optical property of the front cover 3.

In the LED lighting apparatus 1, the reflector 10 is configured to obtain medium-angle light distribution with a 1/10 beam angle of 62° when only the base end side part 40Pa to which mirror finish is applied is used (configuration 1). Further, the reflector 10 is configured to obtain a medium-to-wide-angle light distribution with a 1/10 beam angle of 63° by using an embossed cover that is given a light diffusion effect as the front cover 3 in combination in addition to the configuration 1 (configuration 2). The reflector 10 is configured to obtain a wide-angle light distribution with a 1/10 beam angle of 87° by adopting white coating (that is, light diffusion treatment) instead of mirror finish as the treatment of the reflecting surface of the base end side part 40Pa in the configuration 2 (configuration 3). Further, the reflector 10 is configured to obtain a narrow-angle light distribution with a 1/10 beam angle of 38° by attaching the tip end side part 40Pb in which mirror finish is applied to the reflecting surface 12 to the base end side part 40Pa in addition to the above described configuration 1 (configuration 4). The reflector 10 is configured to obtain a narrow-to-medium-angle light distribution with a 1/10 beam angle of 40° by using the embossed cover to which a light diffusion effect is given in combination as the front cover 3, similarly to the configuration 2, in the configuration 4 (configuration 5).

Here, when the tip end section 12B of the reflector 10 is configured to be disposed in the apparatus main body 2 without being protruded from the apparatus main body 2, there is the fear that light that is emitted from the tip end section 12B of the reflecting surface 12 are incident on the side surface of the apparatus main body 2 or the like and are shielded. In particular, when the tip end side part 40Pb is separated from the base end side part 40Pa, and only the base end side part 40Pa is used as the reflector 10, there is the fear that the base end side part 40Pa is disposed in a position that is recessed from the front opening 7, and a great deal of light is shielded, whereby the apparatus efficiency is reduced.

Therefore, the LED lighting apparatus 1 adopts a configuration in which at least the base end side part 40Pa is protruded from the front opening 7 of the apparatus main body 2, that is, a configuration in which the depth Tc of the apparatus main body 2 is made smaller than the height Te of the base end side part 40Pa, as shown in FIG. 2.

Thereby, even when the reflector 10 is used by removing the tip end side part 40Pb from the reflector 10, a tip end of the base end side part 40Pa is protruded from the apparatus main body 2, and therefore, light can be emitted from the reflector 10 without being shielded by the apparatus main body 2, whereby reduction in the apparatus efficiency is prevented. Further, the depth Tc of the apparatus main body 2 is small, and whereby weight reduction is also achieved.

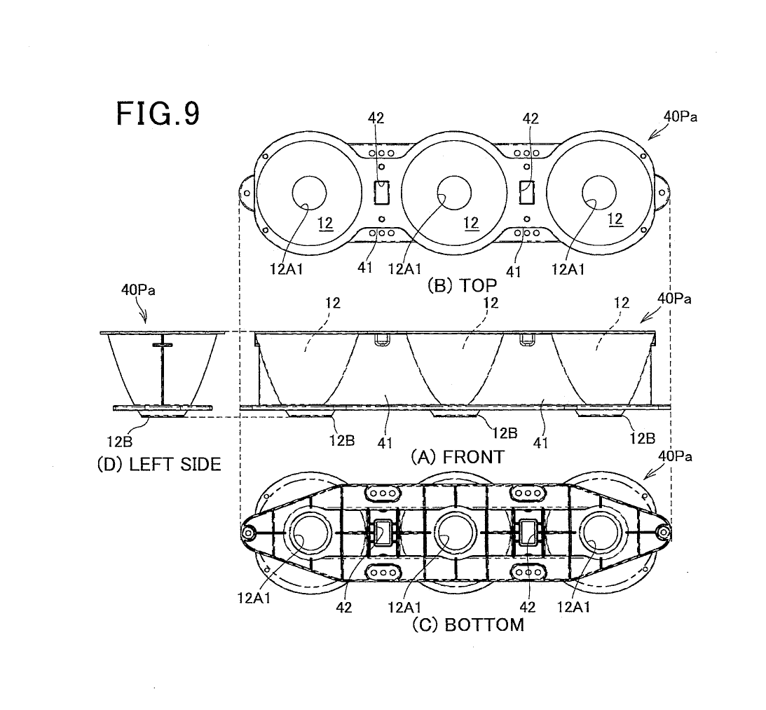

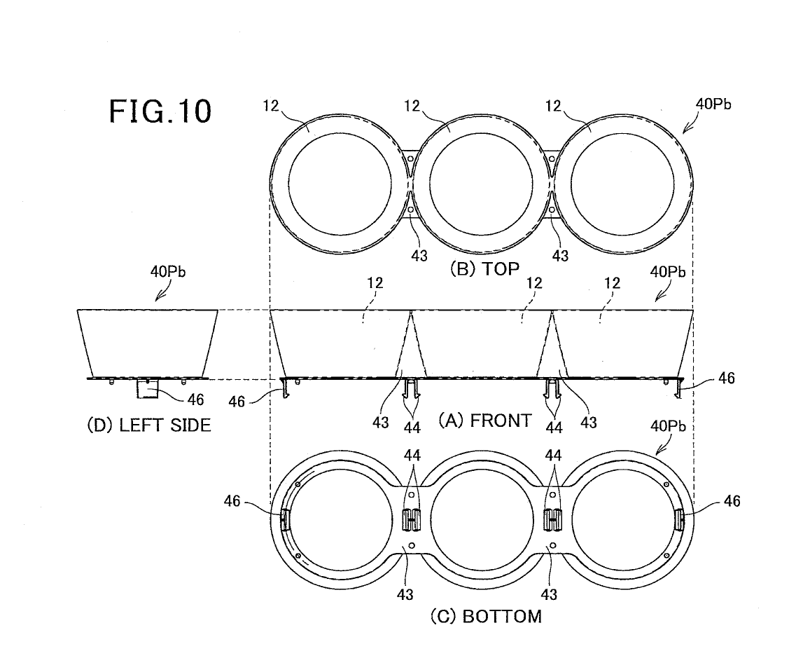

FIG. 8 is a sectional view of the reflector 10. FIG. 9 is a configuration view of the base end side part 40Pa, FIG. 9(A) is a front view, FIG. 9 (B) is a top view, FIG. 9 (C) is a bottom view, and FIG. 9 (D) is a left side view. FIG. 10 is a configuration view of the tip end side part 40Pb, FIG. 10 (A) is a front view, FIG. 10 (B) is a top view, FIG. 10 (C) is a bottom view, and FIG. 10 (D) is a left side view.

As shown in FIG. 8, the reflector 10 integrally has a plurality of reflecting surfaces 12, and the respective reflecting surfaces 12 are disposed laterally side by side, with the central axes O parallel with one another. The reflector 10 includes the base end side part 40Pa and the tip end side part 40Pb so as to separate the respective reflecting surfaces 12 into the base end side and the tip end side. In order to facilitate attachment and detachment of the base end side part 40Pa and the tip end side part 40Pb, an insertion fixing structure is used in fixation of both of them, in the reflector 10.

Describing in detail, as shown in FIG. 8 and FIG. 9 (A), the base end side part 40Pa has connecting sections 41 that connect the adjacent reflecting surfaces 12 of the plurality of the reflecting surfaces 12. As shown in FIG. 8 and FIG. 9 (B), in each of the connecting sections 41, an insertion hole section 42 is formed in a contact surface to the tip end side part 40Pb. Meanwhile, the tip end side part 40Pb also has connecting sections 43 that connect the reflecting surfaces 12 as shown in FIG. 8 and FIG. 10 (A) similarly to the base end side part 40Pa, and in contact surfaces of the connecting sections 43 to the base end side part 40Pa, claw sections 44 are provided to correspond to the insertion hole sections 42. These claw sections 44 and the insertion hole sections 42 configure coupling sections that couple the base end side part 40Pa and the tip end side part 40Pb, and the claw sections 44 are inserted in and engaged to the insertion hole sections 42, whereby the tip end side part 40Pb is coupled to the base end side part 40Pa. Further, in the reflector 10, at both end sides of the tip end side part 40Pb, hook claws 46 that are hooked on projected sections 45 at both end sides of the base end side part 40Pa are provided, and connection of both of them is formed more firmly.

By the insertion connection structure by the claw sections 44 and the insertion hole sections 42, removal, replacement and the like are facilitated by easily inserting and extracting the tip end side part 40Pb into and from the base end side part 40Pa.

In the LED lighting apparatus 1, a plurality of the above described reflectors 10 are arranged inside the apparatus main body 2 so that the mutual reflecting surfaces 12 contact one another, that is, the plurality of reflecting surfaces 12 are disposed most densely in front view, as described above.

In each of the reflectors 10, a screw cramp piece 47 is integrally provided at the base end section 12A of the base end side part 40Pa, as shown in FIG. 9, and each of the reflectors 10 is fixed by screwing the screw cramp piece 47 to the screw cramp section 32 of the apparatus main body 2. After fixation to the apparatus main body 2, the bottom opening 12A1 of each of the reflecting surfaces 12 is disposed above the LED 9, and if a gap is present between the LED 9 and the bottom opening 12A1, light from the LED 9 leaks from the gap to cause reduction in efficiency.

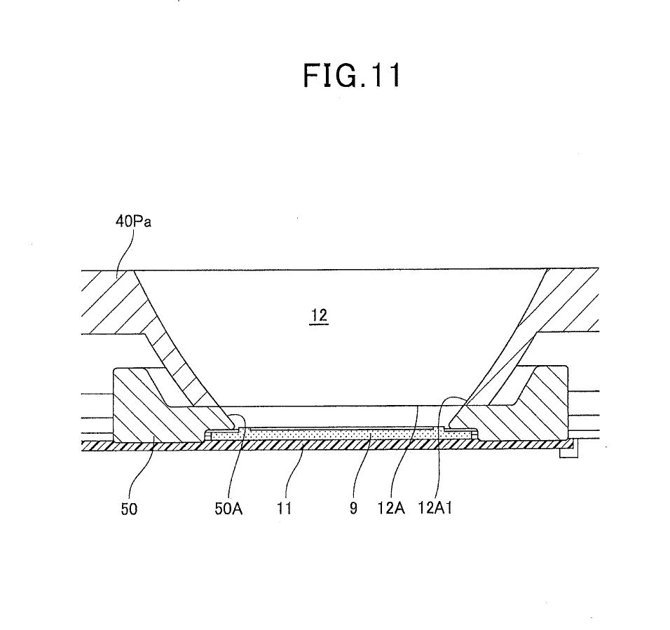

Therefore, as shown in FIG. 11, in the LED lighting apparatus 1, a spacer 50 that is sandwiched by the base end section 12A of the base end side part 40Pa and the ceramics substrate 11, and fills a gap between the LED 9 and the bottom opening 12A1 is provided. The spacer 50 is provided with a surface 50A which continues to the reflecting surface 12 of the base end side part 40Pa, and the surface 50A has reflectiveness, and a shape of the surface 50A corresponds to a surface which is made when the reflecting surface 12 is extended to the side of the LED 9 (that is, a side of the ceramics substrate 11). Thereby, light distribution is also controlled by the surface 50A as well as the reflecting surface 12, and enhancement in efficiency and prevention of uneven luminous intensity are achieved.

The spacer 50 is formed from a resin material that is one example of an elastic material, and is pressed against the ceramics substrate 11 by the base end section 12A as the reflector 10 is screwed to the apparatus main body 2. Thereby, close contact of the ceramics substrate 11 and the bottom surface 2A of the apparatus main body 2 is enhanced, and heat dissipation is enhanced.

As described above, according to the present embodiment, the reflector 10 is made separable into the base end side and the tip end side of the reflecting surface 12, and therefore, the reflector 10 is used by removing the tip end side part 40Pb, or the tip end side part 40Pb is replaced with the one that has a different reflectance property and/or a different light distribution property, whereby the distribution pattern of the reflecting surface 12 can be changed arbitrarily and easily.

Further, since at least the tip end of the base end side part 40Pa protrudes from the apparatus main body 2, even when the reflector 10 is used by removing the tip end side part 40Pb from the reflector 10, the emission light from the reflector 10 is not shielded by the apparatus main body 2, and the apparatus efficiency is not reduced. Further, the depth Tc by which the apparatus main body 2 accommodates the reflector 10 can be made small, and therefore, reduction in weight of the apparatus main body 2 is also achieved.

Further, according to the present embodiment, the coupling section is configured by providing the insertion hole section 42 and the claw section 44 in the base end side part 40Pa and the tip end side part 40Pb of the reflector 10, and therefore, by releasing coupling of the coupling section, removal and replacement can be easily performed. In particular, the coupling section has the structure that is coupled by insertion, and therefore, removal or the like can be performed easily by insertion and extraction of the tip end side part 40Pb into and from the base end side part 40Pa.

Further, by providing the coupling sections in the connecting sections 41 which connect the reflecting surfaces 12, insertion and extraction of the tip end side part 40Pb is enabled with respect to a plurality of reflecting surfaces 12 at a time.

Further, according to the present embodiment, the spacer 50 is provided between the base end side part 40Pa of the reflector 10 and the ceramics substrate 11, and therefore, light that leaks from the gap between the base end side part 40Pa and the ceramics substrate 11 can be prevented. Further, the reflector 10 presses the ceramics substrate 11 through the spacer 50, whereby close contact of the ceramics substrate 11 and the apparatus main body 2 is enhanced.

Further, the surface 50A which continues to the reflecting surface 12 of the base end side part 40Pa is provided in the spacer 50, and the shape of the surface 50A is caused to correspond to the shape of the reflecting surface 12 in a state of the reflecting surface 12 is extended to the side of the ceramics substrate 11.

Thereby, light distribution is also controlled by the surface 50A as well as the reflecting surface 12, and enhancement in efficiency and prevention of unevenness in luminous intensity are achieved.

Further, according to the present embodiment, the reflector 10 is configured to integrally include a plurality of reflecting surfaces 12 which are disposed so that the rotation axes (the central axes O) are parallel with one another. Thereby, light distribution can be changed by attaching and detaching the tip end side parts 40Pb of the plurality of reflecting surfaces 12 simultaneously.

Further, according to the present embodiment, a configuration is provided in which the bosses 15A and 15B for supporting the power supply box 4 with a gap provided between the power supply box 4 and the heat radiation fins 13 are provided to stand in the stand placement space 16 which is made by partially removing the heat radiation fins 13 in the rear surface of the apparatus main body 2.

According to the configuration, the power supply box 4 is supported with the bosses 15A and 15B, and therefore, the heat radiation fins 13 can be also placed at the spots which are covered with the power supply box 4, in the rear surface of the apparatus main body 2.

In particular, at least one of the heat radiation fins 13 is configured to be connected to the bosses 15A and 15B, and therefore heat accumulation in the bosses 15A and 15B is prevented.

Note that the aforementioned embodiment is only illustration of one aspect of the present invention, and can be arbitrarily modified and applied within the range without departing from the gist of the present invention.

In the aforementioned embodiment, the LED is illustrated as one example of a light-emitting element, but other light-emitting elements such as an organic EL can be also used, for example. Further, the light source is not limited to the light-emitting elements.

Further, as the reflector 10, the configuration in which the reflecting surface 12 is separable into two that are the base end side part 40Pa and the tip end side part 40Pb is illustrated. However, the tip end side part 40Pb may be configured to be further separable into two or more.

Further, since in a case where the LED lighting apparatus 1 is installed by being inclined, a deviation of light distribution by the inclination of the optical axis easily occurs due to vibration or the own weight of the reflector 10, such a configuration may be adopted, that prevents inclination of the optical axis by pressing the reflectors 10 with the front cover 3 by causing the inner surface of the front cover 3 which covers the front surface of the apparatus main body 2 to contact the tip ends of the reflectors 10 (the tip ends of the tip end side parts 40Pb in the present embodiment) in order to obtain more stable light distribution.

Further, the LED lighting apparatus 1 which is described in the aforementioned embodiment can illuminate a radiation field at a distance of several tens meters to a hundred and several tens meters with sufficient brightness, and therefore can be favorably used as a floodlight that illuminates a high-rise building. Further, by disposing a plurality of the LED lighting apparatuses 1 side by side, the plurality of the LED lighting apparatuses 1 can be favorably used in stadium lighting that needs to light a wide range from a distant place, such as a baseball ground, and a sports ground.

### REFERENCE SIGNS LIST

1 LED lighting apparatus (lighting apparatus)
2 Apparatus main body
3 Front cover
3A Plane section
4 Power supply box
9 LED (light source, light-emitting element)
10 Reflector
11 Ceramics substrate (mounting substrate)
12 Reflecting surface
12A Base end section
12B Tip end section
12A1 Bottom opening
13 Heat radiation fin
13A Connection section
15A, 15B, 29A, 29B Boss
16 Stand placement space
3A1 Protruded section
40Pa Base end side part
40Pb Tip end side part
42 Insertion hole section (coupling section)
44 Claw section (coupling section)
50 Spacer
50A Surface
O Central axis (rotation axis)

1. A lighting apparatus comprising:
an apparatus main body; and
a light source and a reflector which have a reflecting surface that is in a shape of a curved surface of revolution and are accommodated in the apparatus main body,
wherein the reflector is made separable into a base end side and a tip end side of the reflecting surface, and
a tip end of a part at the base end side is protruded from the apparatus main body.

2. The lighting apparatus according to claim 1, comprising:
a coupling section that couples the part at the base end side and a part at the tip end side of the reflector.

3. The lighting apparatus according to claim 2,
wherein the reflector has a plurality of reflecting surfaces that are connected by a connecting section, and
the coupling section to which the part at the base end side and the part at the tip end side are inserted and coupled is included in the connecting section.

4. The lighting apparatus according to claim 3,
wherein a plurality of the reflectors are included, each of said reflectors being arranged inside the apparatus main body.

5. The lighting apparatus according to claim 1,
wherein the light source comprises a light-emitting element, and a light-emitting element substrate on which the light-emitting element is mounted, and
a spacer is provided between the part at the base end side of the reflector, and the light-emitting element substrate.

6. The lighting apparatus according to claim 5,
wherein the spacer has a surface that continues to a reflecting surface of the part at the base end side of the reflector, and
a shape of the surface is matched with a shape in a state of the reflecting surface being extended to a side of the light-emitting element substrate.

7. The lighting apparatus according claim 1,
wherein the reflector integrally comprises a plurality of the reflecting surfaces that are disposed so that rotation axes are parallel with one another.

8. The lighting apparatus according to claim 1, further comprising:
a power supply box in which an electric circuit that supplies power to the light source is accommodated;
a plurality of heat radiation fins that extend in one direction and is provided on a rear surface of the apparatus main body; and
bosses that support the power supply box with a gap provided between the heat radiation fins and the power supply box are provided to stand in a space that is made by removing part of the heat radiation fins.

9. The lighting apparatus according to claim 8,
wherein at least one of the heat radiation fins is connected to the boss.
